(19) United States
(12) Patent Application Publication
(10) Pub. No.: US 2020/0189456 A1
(43) Pub. Date: Jun. 18, 2020

(54) ILLUMINATED VEHICLE VISOR

(71) Applicant: Ford Global Technologies, LLC, Dearborn, MI (US)

(72) Inventor: Linsheng Chen, Novi, MI (US)

(73) Assignee: Ford Global Technologies, LLC

(21) Appl. No.: 16/223,292

(22) Filed: Dec. 18, 2018

(51) Int. Cl. B60Q 3/252; B60Q 3/66; F21V 8/00

(52) U.S. Cl. CPC B60Q 3/252; B60Q 3/66; G02B 6/0068; G02B 6/0065; G02B 6/0038

(57) ABSTRACT

A vehicle visor includes a light guide positioned within a housing. A first major surface comprising a light extraction feature. A second major surface is coupled to a first reflective element. A plurality of minor surfaces are positioned around a perimeter of the light guide. A light source and a second reflective element each optically coupled with one of the plurality of minor surfaces on opposite sides of the light guide.

### FIELD OF THE INVENTION

The present disclosure generally relates to visors, and more particularly, to illuminated visors for vehicles.

### BACKGROUND OF THE INVENTION

Vehicles typically include visors to block the sun light from entering the vehicle during the daytime. Conventional visors may utilize a mirror and visor light which includes a lens with optics to illuminate driver or passenger's face in low ambient light conditions. Often, the visor light employs an incandescent bulb and a printed circuit board for the control of the visor light.

### SUMMARY OF THE INVENTION

According to one feature of the present disclosure, a vehicle visor includes a light guide positioned within a housing. A first major surface comprising a light extraction feature. A second major surface is coupled to a first reflective element. A plurality of minor surfaces are positioned around a perimeter of the light guide. A light source and a second reflective element each optically coupled with one of the plurality of minor surfaces on opposite sides of the light guide.

According to another aspect of the present invention, a vehicle visor includes a housing. A polymeric light guide is positioned within the housing and comprising first and second major surfaces. The first major surface comprises a light extraction feature. A reflective element is coupled with the second major surface. A light source is positioned to emit light into the light guide. The light extraction feature is configured to emit the light from the light guide.

According to another aspect of the present invention, a vehicle visor includes a polymeric light guide positioned within a housing and comprises first and second major surfaces. The first major surface integrally defines a plurality of light extraction features on opposite ends of the first major surface. A reflective element is coupled with the second major surface. A light source is optically coupled with the light guide such that the light guide is configured to emit light through the light extraction features.

These and other aspects, objects, and features of the present invention will be understood and appreciated by those skilled in the art upon studying the following specification, claims, and appended drawings.

### BRIEF DESCRIPTION OF THE DRAWINGS

In the drawings:

FIG. 1 is a perspective view of an interior of a vehicle including a visor, according to at least one example;

FIG. 2 is a plan view of the visor of FIG. 1, according to at least one example;

FIG. 3A is a schematic cross-section of the visor taken at line IIIA of FIG. 2 in an unilluminated state, according to at least one example; and

FIG. 3B is a schematic cross-section of the visor taken at line IIIB of FIG. 2 in an illuminated state, according to at least one example.

### DETAILED DESCRIPTION OF THE PREFERRED EMBODIMENTS

Additional features and advantages of the invention will be set forth in the detailed description which follows and will be apparent to those skilled in the art from the description or recognized by practicing the invention as described in the following description together with the claims and appended drawings.

As used herein, the term “and/or,” when used in a list of two or more items, means that any one of the listed items can be employed by itself, or any combination of two or more of the listed items, can be employed. For example, if a composition is described as containing components A, B, and/or C, the composition can contain A alone; B alone; C alone; A and B in combination; A and C in combination; B and C in combination; or A, B, and C in combination.

In this document, relational terms, such as first and second, top and bottom, and the like, are used solely to distinguish one entity or action from another entity or action, without necessarily requiring or implying any actual such relationship or order between such entities or actions.

It will be understood by one having ordinary skill in the art that construction of the described disclosure, and other components, is not limited to any specific material. Other exemplary embodiments of the disclosure disclosed herein may be formed from a wide variety of materials, unless described otherwise herein.

For purposes of this disclosure, the term “coupled” (in all of its forms: couple, coupling, coupled, etc.) generally means the joining of two components (electrical or mechanical) directly or indirectly to one another. Such joining may be stationary in nature or movable in nature. Such joining may be achieved with the two components (electrical or mechanical) and any additional intermediate members being integrally formed as a single unitary body with one another or with the two components. Such joining may be permanent in nature, or may be removable or releasable in nature, unless otherwise stated.

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. When the term “about” is used in describing a value or an end-point of a range, the disclosure should be understood to include the specific value or end-point referred to. Whether or not a numerical value or end-point of a range in the specification recites “about,” the numerical value or end-point of a range is intended to include two embodiments: one modified by “about,” and one not modified by “about.” It will be further understood that the end-points of each of the ranges are significant both in relation to the other end-point, and independently of the other end-point.

The terms “substantial,” “substantially,” and variations thereof as used herein are intended to note that a described feature is equal or approximately equal to a value or description. For example, a “substantially planar” surface is intended to denote a surface that is planar or approximately planar. Moreover, “substantially” is intended to denote that two values are equal or approximately equal. In some embodiments, “substantially” may denote values within about 10% of each other.

It is also important to note that the construction and arrangement of the elements of the disclosure, as shown in the exemplary embodiments, is illustrative only. Although only a few embodiments of the present innovations have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts, or elements shown as multiple parts may be integrally formed, the operation of the interfaces may be reversed or otherwise varied, the length or width of the structures, and/or members, or connectors, or other elements of the system, may be varied, and the nature or number of adjustment positions provided between the elements may be varied. It should be noted that the elements and/or assemblies of the system may be constructed from any of a wide variety of materials that provide sufficient strength or durability, in any of a wide variety of colors, textures, and combinations. Accordingly, all such modifications are intended to be included within the scope of the present innovations. Other substitutions, modifications, changes, and omissions may be made in the design, operating conditions, and arrangement of the desired and other exemplary embodiments without departing from the spirit of the present innovations.

It is also to be understood that variations and modifications can be made on the aforementioned structures and methods without departing from the concepts of the present disclosure, and, further, it is to be understood that such concepts are intended to be covered by the following claims, unless these claims, by their language, expressly state otherwise. Further, the claims, as set forth below, are incorporated into and constitute part of this Detailed Description.

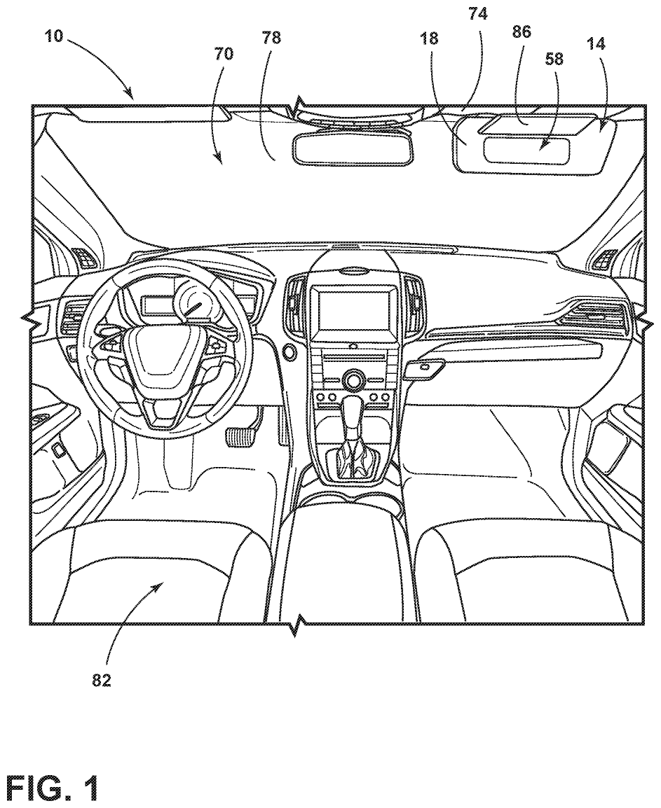

Referring now to FIGS. 1-3B, reference numeral 10 generally designates a vehicle. The vehicle 10 includes a vehicle visor 14. The visor 14 may include a housing 18. A light guide 22 is positioned within the housing 18. The light guide 22 includes a body 26 which defines a first major surface 30 and a second major surface 34. The body 26 may further include or define a plurality of minor surfaces 38 positioned around a perimeter of the body 26. One or more light extraction features 42 may be coupled to the first major surface 30. A first reflective element 46 may be coupled to the second major surface 34. A light source 50 is optically coupled with the light guide 22. A second reflective element 54 is coupled with the light guide 22. According to various examples the light source 50 and the second reflective element 54 are each optically coupled with one of the plurality of minor surfaces 38 on opposite sides of the light guide 22. The combination of light guide 22, light extraction feature 42, first reflective element 46, the light source 50 and/or the second reflective element 54 may generally be referred to herein as a mirror element 58.

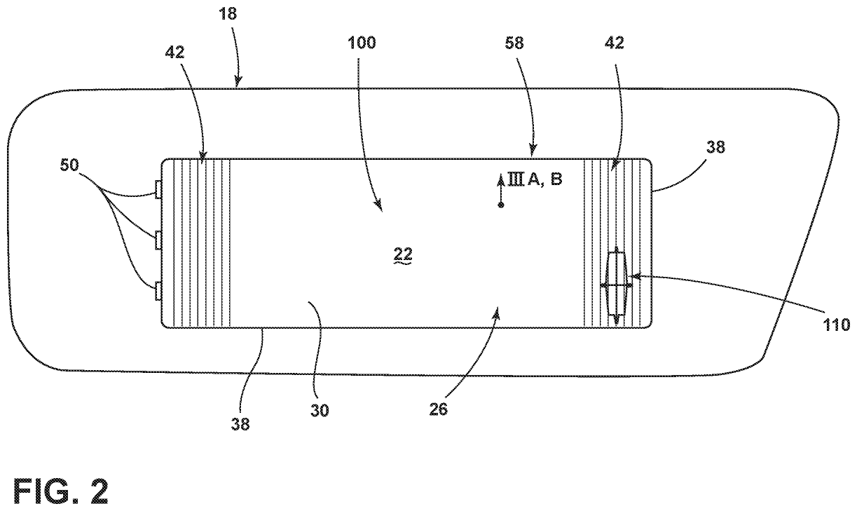

Referring now to FIGS. 1 and 2, the vehicle 10 includes an interior 70 within which the visor 14 is positioned. According to various examples, the visor 14 may be coupled with a headliner 74 of the vehicle 10. In such examples, the visor 14 may be coupled with the headliner 74 vehicle rearward of a windscreen 78 in front of driver and/or passenger seating assemblies 82. Further, it will be understood that the mirror element 58 may be incorporated into various locations of the vehicle 10. For example, the mirror element 58 may be incorporated into back surfaces of the seating assemblies 82 and/or other locations within the interior 70 of the vehicle 10. The visor 14 may be operable between deployed and undeployed positions. The housing 18 of the visor 14 may include a movable door 86 configured to conceal and expose one or more components of the mirror element 58 of the visor 14.

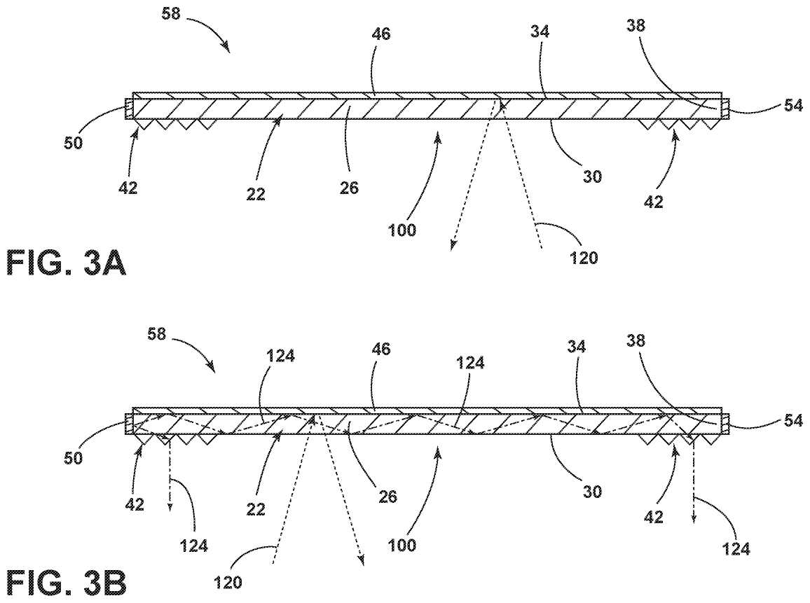

Referring now to FIGS. 2 and 3A, the mirror element 58 of the visor 14 is positioned within the housing 18. The housing 18 may include metal, polymeric and/or cloth components. The housing 18 may include a bezel or other shroud which extends over the mirror element 58 to conceal one or more components of the mirror element 58. For example, the bezel or shroud may extend over the light source 50 such that the light source 50 is concealed. Additionally or alternatively, the bezel or shroud may extend onto the first major surface 30 of the light guide 22. Such a feature may be advantageous in concealing non-aesthetically pleasing edges or peripheral hardware of the mirror element 58.

The light guide 22 may include a variety of materials transparent in the visible region of the electromagnetic spectrum. For example, the light guide 22 may include a glass (e.g., soda-lime float glass, alkaline earth boro-aluminosilicate glass, alkali-aluminosilicate glass, borosilicate glass), a polymeric material, a mixture of polymers and/or plastics and/or combinations thereof. In polymeric examples, the light guide 22 may include a polymeric material composed of one or more of cycloolefin, polyethylene terephthalate, polyethylene naphthalate, polyimide, high density polyethylene, polysulfone, acrylic, polycarbonate, acrylonitrile butadiene styrene, polychlorotrifluoroethylene, polyphenylene sulfide, poly(methyl methacrylate), polyvinyl alcohol, ethylene vinyl alcohol.

The light guide 22 may have a thickness (e.g., as measured from the minimum or maximum distance between first and second major surfaces 30, 34) of from about 0.1 mm to about 5 mm or any and all values and ranges therebetween. Further, the thickness of the light guide 22 may vary with position. The light guide 22 may take a variety of shapes including square (e.g., four minor surfaces 38), rectangular (e.g., four minor surfaces 38), circular (e.g., one minor surface 38), oblong (e.g., two minor surfaces 38), triangular (e.g., three minor surfaces 38), higher order polygons and combinations thereof. According to various examples the first and/or second major surfaces 30, 34 may be substantially planar. Further, one or more of the plurality of minor surfaces 38 may be substantially planar or curved.

According to various examples, the first major surface 30 includes one or more light extraction features 42. It will be understood that the second major surface 34 may also include one or more light extraction features 42 in a similar manner to that described herein with connection to the first major surface 30 without departing from the teachings provided herein. The one or more light extraction features 42 may be integrally defined by the light guide 22 (i.e., formed directly into the light guide 22) and/or may be coupled to the light guide 22 (i.e., a separate structure optically coupled with the first major surface 30 of the light guide 22). As will be explained in greater detail below, the one or more light extraction features 42 are configured to break or otherwise end total internal reflection of light form the light source 50 in the light guide 22 such that light is emitted from the light extraction features 42. The one or more light extraction features 42 may include prisms or other aberrations (e.g., slots, grooves, roughening, etc.) in the shape and/or refractive index of the first major surface 30 of the light guide 22 such that light which is totally internally reflected by the light guide 22 is otherwise allowed to exit the light guide 22 through the light extraction features 42. In other words, the light extraction features 42 are configured to emit the light from the light guide 22 and/or from the light source 50. In integrally defined examples of the light extraction features 42, the light extraction features 42 may be raised (e.g., embossed) or lowered (e.g., debossed) relative to the shape of the first major surface 30.

The first major surface 30 may include a single light extraction feature 42 or a plurality of light extraction features 42. In single light extraction feature 42 examples, the light extraction feature 42 may be a single discrete feature positioned proximate an edge of the light guide 22 or may extend in a continuous and/or unbroken manner around a portion of a perimeter of the first major surface 30 of the light guide 22. In examples of the light guide 22 which include a plurality of light extraction features 42, the light extraction features 42 may be positioned across the first major surface 30. For example, the first major surface 30 may include two light extraction features 42 positioned at opposite ends of the light guide 22. It will be understood that the light extraction features 42 may be positioned at a variety of locations and in a variety of patterns across the first major surface 30 without departing from the teachings provided herein. According to various examples, the first major surface 30 may define one or more planar portions 100 which extend across a portion of the first major surface 30 between the light extraction features 42. As will be explained below, the planar portion 100 may allow a viewer of the visor 14 to use the mirror element 58 as a mirror while the mirror element 58 and/or visor 14 is in the illuminated state.

The visor 14 and/or mirror element 58 may include one or more light sources 50 optically coupled with the light guide 22. The one or more light sources 50 may include an incandescent bulb, a light emitting diode, or other forms of light generation. The one or more light source 50 may be configured to emit white light, colored light, non-visible light (e.g., ultraviolet) or other electromagnetic spectra. In the depicted example, the light sources 50 are positioned on a single side of the light guide 22, but it will be understood that there may be several groupings of light sources 50 positioned around the light guide 22 or that the light sources 50 may be scattered around the perimeter of the light guide 22. As will be explained in greater detail below, the one or more light sources 50 may be optically coupled to the light guide 22 or positioned to emit light into the light guide 22 at a launch angle configured to produce total internal reflection of the light within the light guide 22.

The visor 14 and/or mirror element 58 may include the first reflective element 46 and the second reflective element 54. The first reflective element 46 is generally coupled to the second major surface 34 and the second reflective element 54 is generally coupled to one or more of the plurality of minor surfaces 38. The first and/or second reflective elements 46, 54 may be reflective, partially transmissive and/or transflective. It will be understood that the optical properties of the first and/or second reflective elements 46, 54 may be different than one another and further may vary across the length of the first and/or second reflective elements 46, 54. In reflective examples, the first and/or second reflective elements 46, 54 may include a metal film, a metal foil, a vacuum metallized coating, other reflective and transflective materials and/or combinations thereof. The first and/or second reflective elements 46, 54 may be directly coupled (i.e., deposited or directly adhered to) the second major surface 34 and plurality of minor surfaces 38 or may be supported by a separate substrate and coupled through close proximity.

According to various examples, the light guide 22 may include one or more indicia 110. Similarly to the light extraction features 42 the indicia 110 may be integrally formed (e.g., engraved) in the light guide 22 or may be a separate structure optically coupled to the light guide 22. The indicia 110 may be positioned on the first and/or second major surfaces 30, 34 of the light guide 22. The indicia 110 may form alphanumeric text, symbols, pictures and/or other elements configured to convey information of an aesthetically pleasing look. The indicia 110 is coupled to the light guide 22 such that when internally reflected light inside the light guide 22 strikes the indicia 110, the light will exit the light guide 22 in a similar manner to the light extraction feature 42 and the indicia 110 will be visible.

Referring now to FIGS. 3A and 3B, in operation, the mirror element 58 of the visor 14 is operable in an unilluminated state (FIG. 3A) and an illuminated state (FIG. 3B). The unilluminated state of the mirror element 58 may be utilized in day light or high ambient light conditions. In the unilluminated state, incident ambient light 120 passed through the planar portion 100 of the light guide 22, and is specularly reflected by the first reflective element 46 back through the light guide 22. As such, the planar portion 100 of the light guide 22 allows the mirror element 58 to function as a conventional mirror.

In the illuminated state of FIG. 3B, the light source 50 is configured to emit light 124 into one or more of the plurality of minor surfaces 38 of the light guide 22. The light source 50 may be coupled to the light guide 22 such that a launch angle of the light 124 into the light guide 22 results in the total internal reflection of the light 124 within the light guide 22. Total internal reflection of the light 124 is governed by Snell's Law provided in Equation 1:

sin(α₁)*η₁=sin(α₂) (Eq. 1)

where α₁ is the internal angle of incidence of the light 124 within the light guide 22, η₁ is the refractive index of the material of the light guide 22, α₂ is the calculated external angle of incidence of the light 124, η₂ is the refractive index of the medium proximate the first or second major surfaces 30, 34. By tailoring the refractive index of the light guide 22 and the angle at which the light 124 impinges on the first and/or second major surfaces 30, 34, the light 124 may be propagated through the light guide 22 through total internal reflection. It is important to note that although reflection of the light 124 occurs at the second major surface 34 such reflection is largely due to the total internal reflection as opposed to reflection from the first reflective element 46. The light 124 will be internally reflected within the light guide 22 until it reaches a light extraction feature 42. Due to the shape of the light extraction feature 42, the angle the light 124 impinges on the first major surface 30 may exceed a critical angle at which the total internal reflection is broken. As a result, the light 124 exits the light guide 22 though the light extraction feature 42. In other words, the light 124 of the light source 50 is emitted through the light extraction feature 42. Light 124 which has not exited the light guide 22 through one of the light extraction features 42 may continue to be internally reflected through the planar portion 100 of the light guide 22 and reach the other light extraction feature 42 where it may undergo a similar extraction from the light guide 22. If the light 124 reaches an opposite minor surface 38 of the light guide 22, the second reflective element 54 may reflect the light 124 back into the light guide 22 such that the light 124 may eventually be emitted through one of the light extraction features 42. As such, a viewer of the mirror element 58 of the visor 14, in the illuminated state of the depicted example, would perceive a mirror like center (e.g., the planar portion 100) with lights (e.g., the light extraction features 42) positioned at the perimeter of the mirror element 58.

Use of the present disclosure may offer a variety of advantages. First, use of the presently disclosed mirror element 58 and visor 14 may eliminate the use of conventional lens, bulb and sockets. Such a feature may be advantageous in decreasing the overall cost and manufacturing complexity of assembling the visor 14 and/or mirror element 58 while also providing a thinner design. Further, use of polymeric examples of the light guide 22 may save weight and manufacturing expense as compared to conventional glass elements.

Second, use of the presently disclosed visor 14 and/or mirror element 58 may provide an aesthetically pleasing appearance to a viewer. For example, as the light extraction features 42 and the indicia 110 are concealed while the mirror element 58 is in the unilluminated state, transitioning the mirror element 58 to the illuminated state may be advantageous in surprising and delighting viewers to see the indicia 110 and the light 124 emitted from the light extraction features 42.

According to various embodiments, a vehicle visor, includes: a light guide positioned within a housing and comprising: a first major surface comprising a light extraction feature; a second major surface coupled to a first reflective element; and a plurality of minor surfaces positioned around a perimeter of the light guide; and a light source and a second reflective element each optically coupled with one of the plurality of minor surfaces on opposite sides of the light guide. Embodiments of the vehicle wheel assembly can include any one or a combination of the following features:
the light extraction feature is integrally defined by the light guide;
the light extraction feature is coupled with the light guide;
the light source comprises a light emitting diode;
the light source is configured to emit light into the light guide;
the light guide comprises a polymeric material;
the light guide comprises poly(methyl methacrylate);
the light extraction feature is configured to emit the light from the light guide;
the first major surface defines a substantially planar portion;
the first major surface defines a substantially planar portion positioned between a plurality of light extraction features;
the second major surface is substantially planar;
the light source is positioned to emit light into the light guide at a launch angle configured to produce total internal reflection of the light within the light guide;
the light extraction feature defines an indicia; and/or
the first major surface integrally defines a plurality of light extraction features on opposite ends of the first major surface.

What is claimed is:

1. A vehicle visor, comprising:
a light guide positioned within a housing and comprising:
a first major surface comprising a light extraction feature;
a second major surface coupled to a first reflective element; and
a plurality of minor surfaces positioned around a perimeter of the light guide; and
a light source and a second reflective element each optically coupled with one of the plurality of minor surfaces on opposite sides of the light guide.

2. The vehicle visor of claim 1, wherein the light extraction feature is integrally defined by the light guide.

3. The vehicle visor of claim 1, wherein the light extraction feature is coupled with the light guide.

4. The vehicle visor of claim 1, wherein the light guide defines an indicia.

5. The vehicle visor of claim 1, wherein the light source is configured to emit light into the light guide.

6. The vehicle visor of claim 1, wherein the light guide comprises a polymeric material.

7. The vehicle visor of claim 6, wherein the light guide comprises poly(methyl methacrylate).

8. The vehicle visor of claim 1, wherein the light source comprises a light emitting diode.

9. The vehicle visor of claim 1, wherein the first major surface defines a substantially planar portion.

10. A vehicle visor, comprising:
a housing;
a polymeric light guide positioned within the housing and comprising first and second major surfaces, wherein the first major surface comprises a light extraction feature;
a reflective element coupled with the second major surface; and
a light source positioned to emit light into the light guide, wherein the light extraction feature is configured to emit the light from the light guide.

11. The vehicle visor of claim 10, wherein the light guide defines an indicia.

12. The vehicle visor of claim 10, wherein the second major surface is substantially planar.

13. The vehicle visor of claim 10, further comprising:
a second reflective element coupled with a minor surface of the polymeric light guide.

14. A vehicle visor, comprising:
a polymeric light guide positioned within a housing and comprising first and second major surfaces, wherein the first major surface integrally defines a plurality of light extraction features on opposite ends of the first major surface;
a reflective element coupled with the second major surface; and
a light source optically coupled with the light guide such that the light guide is configured to emit light through the light extraction features.

15. The vehicle visor of claim 14, wherein the first major surface defines a substantially planar portion positioned between the light extraction features.

16. The vehicle visor of claim 14, wherein the second major surface is substantially planar.

17. The vehicle visor of claim 14, wherein the light source is positioned to emit light into the light guide at a launch angle configured to produce total internal reflection of the light within the light guide.

18. The vehicle visor of claim 14, wherein the light guide defines an indicia.

19. The vehicle visor of claim 14, wherein the light guide comprises poly(methyl methacrylate).

20. The vehicle visor of claim 14, wherein the light source comprises a light emitting diode.
